(19) United States
(12) Patent Application Publication
(10) Pub. No.: US 2011/0019090 A1
(43) Pub. Date: Jan. 27, 2011

(54) VERTICAL SYNCHRONIZATION CONTROLLER

(75) Inventor: Yoshinori NAGATANI, Kanagawa (JP)

Correspondence Address: MCDERMOTT WILL & EMERY LLP, 600 13TH STREET, NW, WASHINGTON, DC, 20005-3096, US

(73) Assignee: PANASONIC CORPORATION, Osaka (JP)

(21) Appl. No.: 12/896,502

(22) Filed: Oct. 1, 2010

Related U.S. Application Data
(63) Continuation of application No. PCT/JP2009/001434, filed on Mar. 30, 2009.

(30) Foreign Application Priority Data
Apr. 3, 2008 (JP) P2008-097301

(51) Int. Cl. H04N 5/10

(52) U.S. Cl. 348/530; 348/E05.018

(57) ABSTRACT

A vertical synchronization controller includes a vertical synchronization separation unit for taking out a vertical synchronizing signal from a decode video signal; a vertical synchronization generation unit for taking out a horizontal synchronizing signal from the decode video signal and generating an internal vertical synchronizing signal; a noise detection unit for detecting the noise amount of the decode video signal; a control unit for determining the current noise state based on the numeric value indicating the noise detection amount, determining whether or not a period of the external vertical synchronizing signal is normal in response to whether or not the external vertical synchronizing signal having the period close to a period of the internal vertical synchronizing signal is input, counting the successive number of times the external vertical synchronizing signal of the normal period has been input, and giving a command responsive to the numeric value indicating the noise detection amount and the successive number of times the external vertical synchronizing signal of the normal period has been input; and a synchronization switch unit for outputting either of the external vertical synchronizing signal and the internal vertical synchronizing signal as a vertical synchronizing signal in response to the command from the control unit.

### BACKGROUND OF THE INVENTION

1. Field of the Invention

This invention relates to a vertical synchronization controller for outputting a vertical synchronizing signal capable of displaying video without shifting a vertical synchronization position even in an environment in which the electric field strength vigorously changes.

2. Description of the Related Art

A TV receiver uses a vertical synchronizing signal as a synchronizing signal in a vertical direction of a display screen, of a horizontal synchronizing signal and the vertical synchronizing signal separated from a decode video signal. The TV receiver determines whether or not a decode synchronizing signal is contained in the decode video signal. If the decode synchronizing signal is contained, the TV receiver operates as a PLL circuit in synchronization with the decode synchronizing signal (external synchronization state); if no decode synchronizing signal is contained, the TV receiver generates an internal synchronizing signal and prevents disorder of the display screen (internal synchronization state). No decode synchronizing signal is contained in the decode video signal in a state in which no video exists as at the tuning time.

Patent Document 1: JP-A-8-237514

### SUMMARY OF THE INVENTION

When a device such as a vehicle-installed device or a portable device having a TV reception function moves, the electric field strength of a decode video signal input to the device vigorously changes. When a decode video signal containing much noise because the electric field strength is low is input to the device, there is a possibility that a vertical synchronization separation circuit that the device has may be unable to detect a vertical synchronizing signal or may make erroneous detection. Detection of the vertical synchronizing signal by the vertical synchronization separation circuit becomes unstable in a move state of the device. In such an environment, the vertical synchronization position shifts although a vertical synchronization frequency can be kept correct in the internal synchronization state described above. The TV receiver described above displays video shifting in the vertical direction relative to the effective display area of the display screen.

It is an object of the invention to provide a vertical synchronization controller capable of displaying video without shifting a vertical synchronization position even in an environment in which the electric field strength vigorously changes.

The invention provides a vertical synchronization controller including a vertical synchronization separation unit configured to take out a vertical synchronizing signal from a decode video signal provided by putting a video signal, a vertical synchronizing signal, and a horizontal synchronizing signal into one and output the vertical synchronizing signal as an external vertical synchronizing signal; a vertical synchronization generation unit configured to take out the horizontal synchronizing signal from the decode video signal and count the number of horizontal synchronizing signals so as to generate an internal vertical synchronizing signal; a noise detection unit configured to detect the noise amount of the decode video signal and output a numeric value responsive to the noise detection amount; a control unit configured to determine whether the current state is a much noise state or a small noise state based on the numeric value indicating the noise detection amount output from the noise detection unit, determine whether or not a period of the external vertical synchronizing signal is normal in response to whether or not the external vertical synchronizing signal having the period close to a period of the internal vertical synchronizing signal generated by the vertical synchronization generation unit is input from the vertical synchronization separation unit, count the successive number of times the external vertical synchronizing signal of the normal period has been input, and give a command responsive to the numeric value indicating the noise detection amount and the successive number of times the external vertical synchronizing signal of the normal period has been input; and a synchronization switch unit configured to output either of the external vertical synchronizing signal output from the vertical synchronization separation unit and the internal vertical synchronizing signal input from the vertical synchronization generation unit as a vertical synchronizing signal in response to the command from the control unit.

In the vertical synchronization controller described above, the control unit may determine the reliability of the external vertical synchronizing signal in response to the comparison result between the count of the successive number of times the external vertical synchronizing signal has been input every period of the internal vertical synchronizing signal and a predetermined threshold value.

In the vertical synchronization controller described above, if the reliability of the external vertical synchronizing signal exceeds a predetermined level, the control unit may command the synchronization switch unit to output the external vertical synchronizing signal as the vertical synchronizing signal and if the reliability of the external vertical synchronizing signal is less than the predetermined level, the control unit commands the synchronization switch unit to output the internal vertical synchronizing signal as the vertical synchronizing signal.

In the vertical synchronization controller described above, the control unit may change the predetermined level compared with the reliability of the external vertical synchronizing signal when the numeric value indicating the noise detection amount exceeds a predetermined threshold value and when the numeric value is less than the predetermined threshold value.

According to the vertical synchronization controller according to the invention, a state in which the internal vertical synchronizing signal generated in the vertical synchronization generation unit is output as the vertical synchronizing signal is set to a basic state and when the reliability of the external vertical synchronizing signal detected by the vertical synchronization separation unit from the decode video signal input from the outside is high, the external vertical synchronizing signal is output as the vertical synchronizing signal, so that the vertical synchronization position does not shift and video can be displayed even in an environment in which the electric field strength vigorously changes.

### BRIEF DESCRIPTION OF THE DRAWINGS

FIG. 1 is a block diagram to show the configuration of an embodiment of a vertical synchronization control circuit according to the invention.

FIG. 2 is a flowchart to show the operation of a control unit 14 performed every vertical synchronization period.

### DESCRIPTION OF THE PREFERRED EMBODIMENTS

An embodiment of the invention will be discussed below with reference to the accompanying drawings:

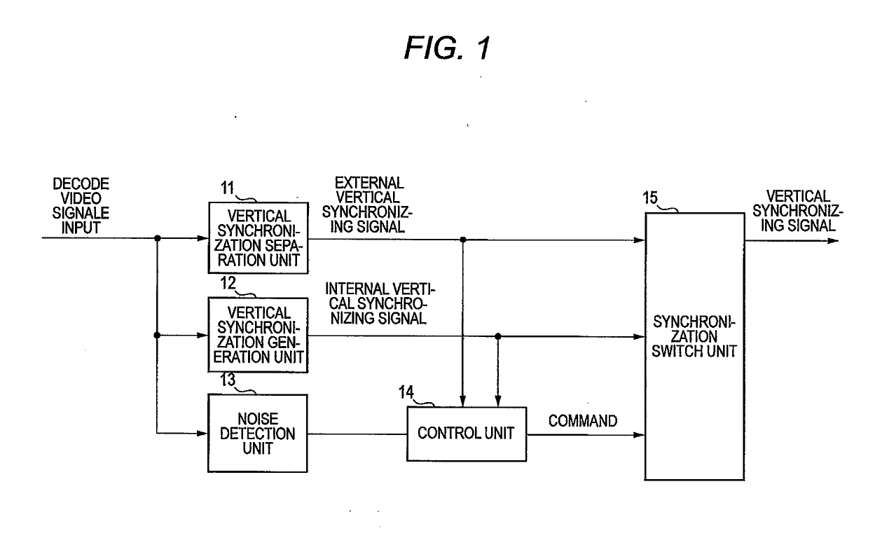

FIG. 1 is a block diagram to show the configuration of an embodiment of a vertical synchronization control circuit according to the invention. The vertical synchronization control circuit shown in FIG. 1 includes a vertical synchronization separation unit 11, a vertical synchronization generation unit 12, a noise detection unit 13, a control unit 14, and a synchronization switch unit 15. A decode video signal provided by putting a video signal, a vertical synchronizing signal, and a horizontal synchronizing signal into one, so-called composite signal is input to the vertical synchronization separation unit 11, the vertical synchronization generation unit 12, and the noise detection unit 13.

The vertical synchronization separation unit 11 takes out only the vertical synchronizing signal from the input decode video signal and outputs the signal as an external vertical synchronizing signal. The external vertical synchronizing signal is input to the control unit 14 and the synchronization switch unit 15. The vertical synchronization generation unit 12 takes out the horizontal synchronizing signal from the decode video signal and counts the number of taken-out horizontal synchronizing signals, thereby generating an internal vertical synchronizing signal. The internal vertical synchronizing signal is input to the control unit 14 and the synchronization switch unit 15. The noise detection unit 13 detects the noise amount of the decode video signal and reports the numeric value responsive to the noise detection amount to the control unit 14. The numeric value responsive to the noise detection amount is higher as the noise detection amount is larger.

The control unit 14 determines whether the current state is a much noise state or a small noise state based on the numeric value indicating the noise detection amount reported from the noise detection unit 13. The control unit 14 determines whether or not the period of an external vertical synchronizing signal is normal in response to whether or not the external vertical synchronizing signal having a period of a value close to the period of the internal vertical synchronizing signal generated in the vertical synchronization generation unit 12, and counts the successive number of times an external vertical synchronizing signal of the normal period has been input. The control unit 14 commands the synchronization switch unit 15 to switch the state to either of an external vertical synchronization state and an internal vertical synchronization state described later in response to the numeric value indicating the noise detection amount and the successive number of times an external vertical synchronizing signal of the normal period has been input.

The synchronization switch unit 15 outputs either of the external vertical synchronizing signal input from the vertical synchronization separation unit 11 and the internal vertical synchronizing signal input from the vertical synchronization generation unit 12 as a vertical synchronizing signal in response to the command from the control unit 14. The state operating based on the external vertical synchronizing signal is called “external vertical synchronization state” and the state operating based on the internal vertical synchronizing signal is called “internal vertical synchronization state.” The control unit 14 of the embodiment usually operates in the internal vertical synchronization state.

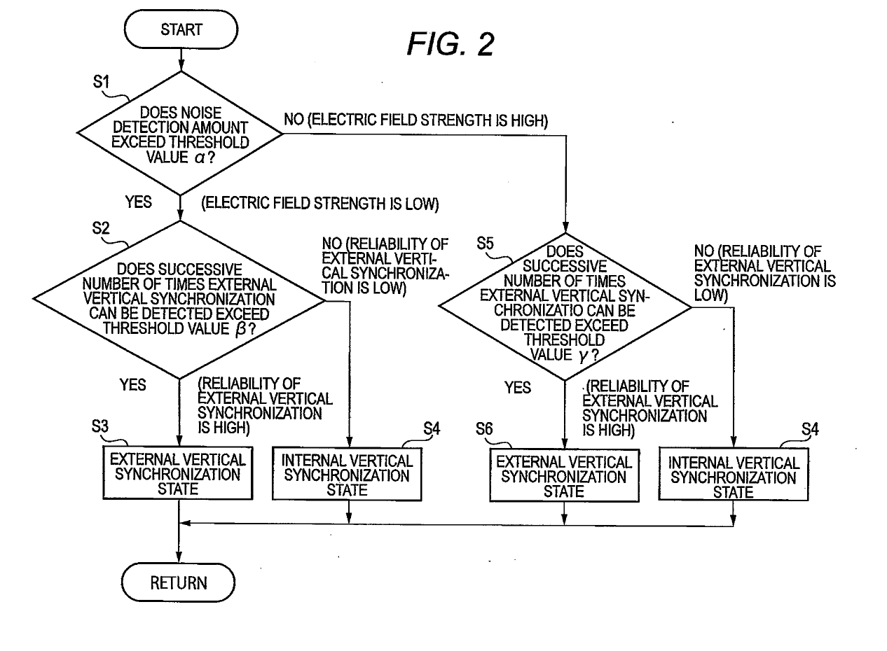

The operation of the control unit 14 will be discussed below with reference to FIG. 2: FIG. 2 is a flowchart to show the operation of the control unit 14 performed every vertical synchronization period. As shown in FIG. 2, the control unit 14 operating in the internal vertical synchronization state at the usual time determines whether or not the numeric value indicating the noise detection amount reported from the noise detection unit 13 exceeds a threshold value α (step S1). When the numeric value exceeds the threshold value α, noise is much and thus it is determined that the electric field strength is low. If the numeric value is equal to or less than the threshold value α, noise is small and thus it is determined that the electric field strength is high.

If the numeric value indicating the noise detection amount exceeds the threshold value α and it is determined that the electric field strength is low at step S1, the control unit 14 makes a comparison between the period of the external vertical synchronizing signal input from the vertical synchronization separation unit 11 and the internal vertical synchronizing signal input from the vertical synchronization generation unit 12 and makes a comparison between the count of the successive number of times the external vertical synchronizing signal has been input every period of the internal vertical synchronizing signal and a threshold value β (step S2). If the count exceeds the threshold value β, the control unit 14 determines that the reliability of the external vertical synchronizing signal is high, and commands the synchronization switch unit 15 to output the external vertical synchronizing signal as a vertical synchronizing signal (step S3). On the other hand, if the count is equal to or less than the threshold value β, the control unit 14 determines that the reliability of the external vertical synchronizing signal is low, and commands the synchronization switch unit 15 to output the internal vertical synchronizing signal as a vertical synchronizing signal (step S4).

If the numeric value indicating the noise detection amount is equal to or less than the threshold value α and it is determined that the electric field strength is high at step S1, the control unit 14 makes a comparison between the period of the external vertical synchronizing signal input from the vertical synchronization separation unit 11 and the internal vertical synchronizing signal input from the vertical synchronization generation unit 12 and makes a comparison between the count of the successive number of times the external vertical synchronizing signal has been input every period of the internal vertical synchronizing signal and a threshold value γ (step S5). If the count exceeds the threshold value γ, the control unit 14 determines that the reliability of the external vertical synchronizing signal is high, and commands the synchronization switch unit 15 to output the external vertical synchronizing signal as a vertical synchronizing signal (step S6). On the other hand, if the count is equal to or less than the threshold value γ, the control unit 14 determines that the reliability of the external vertical synchronizing signal is low, and commands the synchronization switch unit 15 to output the internal vertical synchronizing signal as a vertical synchronizing signal (step S7). After the control unit 14 commands the synchronization switch unit 15 to set the vertical synchronization state, the synchronization switch unit 15 outputs the commanded vertical synchronizing signal in the vertical synchronization period and the process returns to step S1.

As described above, the vertical synchronization control circuit of the embodiment detects the noise detection amount and the reliability of the external vertical synchronization every vertical synchronization period and switches the internal vertical synchronization state and the external vertical synchronization state in response to the result. Thus, the vertical synchronization position does not shift and video can be displayed in the valid effective display area even in an environment in which the electric field strength vigorously changes.

While the invention has been described in detail with reference to the specific embodiments, it will be obvious to those skilled in the art that various changes and modifications can be made without departing from the spirit and the scope of the invention.

The vertical synchronization controller according to the invention is useful as a vertical synchronization controller, etc., of a TV receiver, etc., installed in a device used in an environment in which the electric field strength vigorously changes as the device such as a vehicle-installed device or a portable device moves. If the device is a stationary device, the vertical synchronization controller is also useful as a vertical synchronization controller, etc., of a TV receiver, etc., installed in the device used in an environment in which the electric field strength vigorously changes.

The disclosure of the Japanese Patent Application (No. 2008-097301) that is filed on Apr. 3, 2008 and PCT application (PCT/JP2009/001434) filed on Mar. 30, 2009, including specification, drawings and claims is incorporated herein by reference in its entirety.

What is claimed is:

1. A vertical synchronization controller, comprising:
a vertical synchronization separation unit configured to take out a vertical synchronizing signal from a decode video signal provided by putting a video signal, a vertical synchronizing signal, and a horizontal synchronizing signal into one and output the vertical synchronizing signal as an external vertical synchronizing signal;
a vertical synchronization generation unit configured to take out the horizontal synchronizing signal from the decode video signal and count the number of horizontal synchronizing signals so as to generate an internal vertical synchronizing signal;
a noise detection unit configured to detect the noise amount of the decode video signal and output a numeric value responsive to the noise detection amount;
a control unit configured to determine whether the current state is a much noise state or a small noise state based on the numeric value indicating the noise detection amount output from the noise detection unit, determine whether or not a period of the external vertical synchronizing signal is normal in response to whether or not the external vertical synchronizing signal having the period close to a period of the internal vertical synchronizing signal generated by the vertical synchronization generation unit is input from the vertical synchronization separation unit, count the successive number of times the external vertical synchronizing signal of the normal period has been input, and give a command responsive to the numeric value indicating the noise detection amount and the successive number of times the external vertical synchronizing signal of the normal period has been input; and
a synchronization switch unit configured to output either of the external vertical synchronizing signal output from the vertical synchronization separation unit and the internal vertical synchronizing signal input from the vertical synchronization generation unit as a vertical synchronizing signal in response to the command from the control unit.

2. The vertical synchronization controller as claimed in claim 1, wherein the control unit determines the reliability of the external vertical synchronizing signal in response to the comparison result between the count of the successive number of times the external vertical synchronizing signal has been input every period of the internal vertical synchronizing signal and a predetermined threshold value.

3. The vertical synchronization controller as claimed in claim 2, wherein if the reliability of the external vertical synchronizing signal exceeds a predetermined level, the control unit commands the synchronization switch unit to output the external vertical synchronizing signal as the vertical synchronizing signal and if the reliability of the external vertical synchronizing signal is less than the predetermined level, the control unit commands the synchronization switch unit to output the internal vertical synchronizing signal as the vertical synchronizing signal.

4. The vertical synchronization controller as claimed in claim 3, wherein the control unit changes the predetermined level compared with the reliability of the external vertical synchronizing signal when the numeric value indicating the noise detection amount exceeds a predetermined threshold value and when the numeric value is less than the predetermined threshold value.
